(19) United States
(12) Patent Application Publication
(10) Pub. No.: US 2015/0062080 A1
(43) Pub. Date: Mar. 5, 2015

(54) TOUCH SCREEN DRIVING DEVICE

(71) Applicant: LG DISPLAY CO., LTD., Seoul (KR)

(72) Inventor: Hyeongwon Kang, Seoul (KR)

(73) Assignee: LG DISPLAY CO., LTD.

(21) Appl. No.: 14/473,144

(22) Filed: Aug. 29, 2014

(30) Foreign Application Priority Data
Aug. 30, 2013 (KR) 10-2013-0104348

(51) Int. Cl. G09G 5/18; G06F 3/044

(52) U.S. Cl. CPC G09G 5/18; G06F 3/044
USPC 345/174

(57) ABSTRACT

A touch screen driving device includes a touch screen including adjacent first and second Tx channels, an Rx channel crossing the first and second Tx channels, a first sensor capacitor formed at a crossing of the first Tx channel and the Rx channel, and a second sensor capacitor formed at a crossing of the second Tx channel and the Rx channel, a Tx driving circuit which supplies a Tx driving signal of a first phase to the first Tx channel and supplies a Tx driving signal of a second phase, which is in antiphase of the first phase, to the second Tx channel, and an integrator which receives a voltage difference between a first voltage of the first sensor capacitor and a second voltage of the second sensor capacitor through the Rx channel and accumulate the received voltage difference several times.

This application claims the benefit of priority to Korea Patent Application No. 10-2013-0104348 filed on Aug. 30, 2013, which is incorporated herein by reference for all purposes as if fully set forth herein.

### BACKGROUND

1. Field of the Disclosure

Embodiments of the disclosure relate to a touch screen driving device.

2. Discussion of the Related Art

A user interface (UI) is configured so that users are able to communicate with various electronic devices and thus can easily and comfortably control the electronic devices as they desire. Examples of the user interface include a keypad, a keyboard, a mouse, an on-screen display (OSD), and a remote controller having an infrared communication function or a radio frequency (RF) communication function. User interface technology has continuously expanded to increase user's sensibility and handling convenience. The user interface has been recently developed to include touch UI, voice recognition UI, 3D UI, etc.

Recently, the touch UI has been used in portable information appliances and has been expanded to the use of home appliances. A mutual capacitive touch screen has been recently considered as an example of a touch screen for implementing the touch UI. The mutual capacitive touch screen can sense a proximity input as well as a touch input and also can recognize respective multi-touch (or multi-proximity) inputs.

The mutual capacitive touch screen includes Tx channels, Rx channels crossing the Tx channels, and sensor capacitors formed at crossings of the Tx channels and the Rx channels. Each sensor capacitor has a mutual capacitance. A touch screen driving device senses changes in voltages charged to the sensor capacitors before and after a touch operation and decides whether or not there is a touch (or proximity) input using a conductive material. Further, the touch screen driving device finds out a position of the touch input when there is the touch input. To sense the voltages charged to the sensor capacitors, a Tx driving circuit applies a driving signal to the Tx channels, and an Rx driving circuit samples a small change in the voltages of the sensor capacitors in synchronization with the driving signal and performs an analog-to-digital conversion.

In general, examples of a factor reducing a signal-to-noise ratio (SNR) of touch data include a channel noise depending on the arrangement of channels and structural characteristics of the touch screen, and an external noise. Examples of the external noise include a floating body, 3-wavelength noise, and a charge noise. Examples of the channel noise include a high frequency noise/low frequency noise of an input signal, channel DC offset, and an interference noise between channels.

A deviation between touch data of channels is generated by different resistor parameters and different capacitor parameters in the touch screens of various structures. Even in the same touch screen, a deviation between touch data input to a touch integrated circuit (IC) is generated by the variation of an influence of an external environment (for example, PCB routing, external noise, etc.) depending on a position and the variation of the resistor parameter and the capacitor parameter. The deviation reduces the signal-to-noise ratio of the touch data and thus reduces touch reliability.

### SUMMARY

In one aspect, a touch screen driving device comprises a touch screen including a first Tx channel, a second Tx channel adjacent to the first Tx channel, an Rx channel crossing the first and second Tx channels, a first sensor capacitor formed at a crossing of the first Tx channel and the Rx channel, and a second sensor capacitor formed at a crossing of the second Tx channel and the Rx channel, a Tx driving circuit configured to supply a Tx driving signal of a first phase to the first Tx channel and supply a Tx driving signal of a second phase, which is in antiphase of the first phase, to the second Tx channel, and an integrator configured to receive a voltage difference between a first voltage of the first sensor capacitor by the Tx driving signal of the first phase and a second voltage of the second sensor capacitor by the Tx driving signal of the second phase through the Rx channel and accumulate the received voltage difference several times.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram of a display device according to an exemplary embodiment of the invention;

FIG. 2 shows a touch screen driving device shown in FIG. 1;

FIGS. 3 to 5 illustrate various combinations of a touch screen and a display panel according to an exemplary embodiment of the invention;

FIG. 6 shows that Tx driving signals of antiphase are supplied to sensor capacitors formed at crossings of Tx channels and Rx channels on a touch screen and adjacent Tx channels;

FIG. 7 shows in detail a driving waveform of Tx driving signals;

FIG. 8 shows detailed configuration of a touch screen and an Rx driving circuit for increasing a signal-to-noise ratio (SNR) of touch data; and

FIG. 9 illustrates one sensing unit shown in FIG. 8.

### DETAILED DESCRIPTION OF THE ILLUSTRATED EMBODIMENTS

Reference will now be made in detail to embodiments of the invention, examples of which are illustrated in the accompanying drawings. Wherever possible, the same reference numbers will be used throughout the drawings to refer to the same or like parts. It will be paid attention that detailed description of known arts will be omitted if it is determined that the arts can mislead the embodiments of the invention. In the following description, a Tx channel may be used as a Tx line, and an Rx channel may be used as an Rx line.

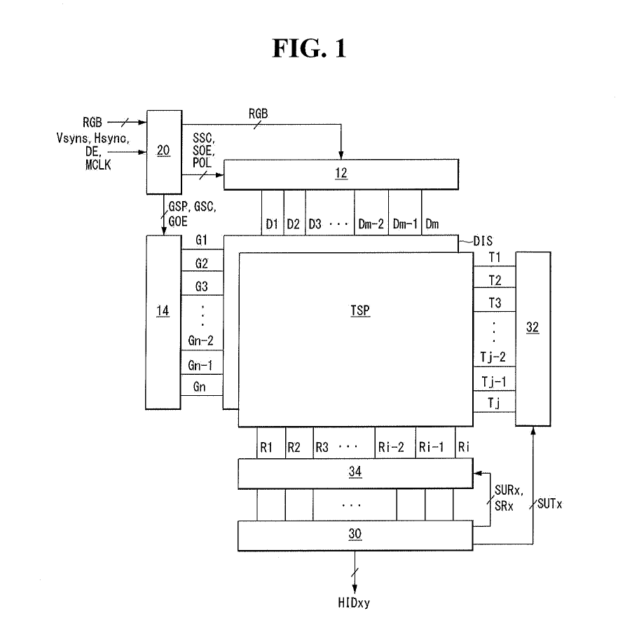

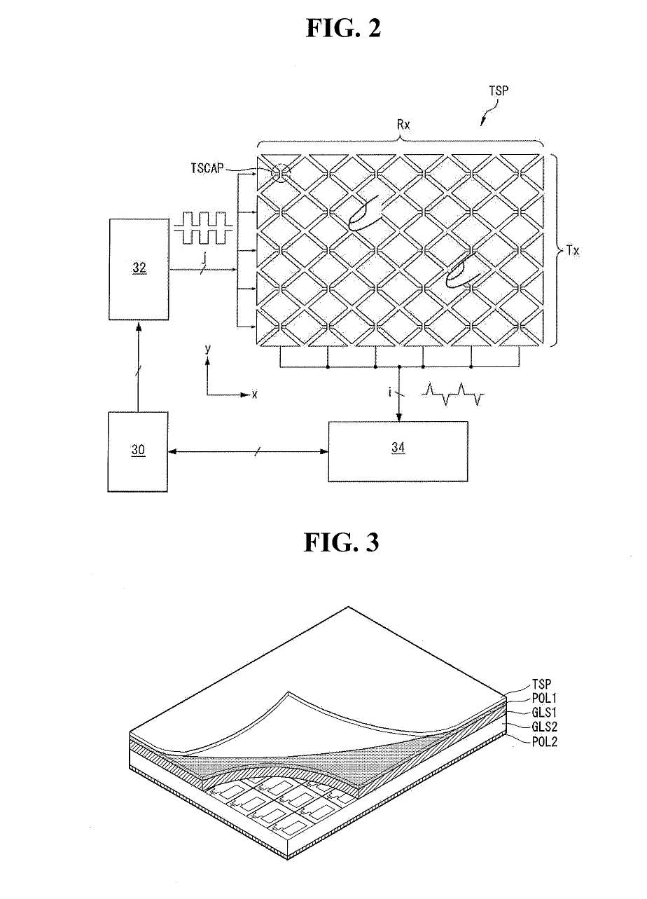

FIG. 1 is a block diagram of a display device according to an exemplary embodiment of the invention. FIG. 2 shows a touch screen driving device shown in FIG. 1. FIGS. 3 to 5 illustrate various combinations of a touch screen and a display panel according to the embodiment of the invention.

As shown in FIGS. 1 to 5, a display device according to the embodiment of the invention includes a display panel DIS, a display driving circuit, a timing controller 20, a touch screen TSP, a touch screen driving circuit, a touch controller 30, and the like. All components of the display device may be operatively coupled and configured.

The display device according to the embodiment of the invention may be implemented based on a flat panel display, such as a liquid crystal display (LCD), a field emission display (FED), a plasma display panel (PDP), an organic light emitting display, and an electrophoresis display (EPD). In the following description, the embodiment of the invention will be described using the liquid crystal display as an example of the flat panel display. Other flat panel displays may be used.

The display panel DIS includes a lower substrate GLS2, an upper substrate GLS1, and a liquid crystal layer formed between the lower substrate GLS2 and the upper substrate GLS1. The lower substrate GLS2 of the display panel DIS includes a plurality of data lines D1 to Dm (where m is a natural number), a plurality of gate lines (or scan lines) G1 to Gn crossing the data lines D1 to Dm (where n is a natural number), a plurality of thin film transistors (TFTs) formed at crossings of the data lines D1 to Dm and the gate lines G1 to Gn, a plurality of pixel electrodes for charging liquid crystal cells to a data voltage, a plurality of storage capacitors, each of which is connected to the pixel electrode and holds a voltage of the liquid crystal cell, and the like.

Pixels of the display panel DIS are respectively formed in pixel areas defined by the data lines Dl to Dm and the gate lines G1 to Gn and are arranged in a matrix form. The liquid crystal cell of each pixel is driven by an electric field generated based on a difference between the data voltage supplied to the pixel electrode and a common voltage supplied to a common electrode, thereby adjusting an amount of incident light transmitted by the liquid crystal cell. The TFTs are turned on in response to a gate pulse (or a scan pulse) from the gate lines G1 to Gn, thereby supplying the data voltage from the data lines D1 to Dm to the pixel electrodes of the liquid crystal cells.

The upper substrate GLS1 of the display panel DIS may include black matrixes, color filters, and the like. The lower substrate GLS2 of the display panel DIS may be configured in a COT (color filter on TFT) structure. In this instance, the black matrixes and the color filters may be formed on the lower substrate GLS2 of the display panel DIS.

Polarizing plates POL1 and POL2 are respectively attached to the upper and lower substrates GLS1 and GLS2 of the display panel DIS. Alignment layers for setting a pre-tilt angle of liquid crystals are respectively formed on the inner surfaces contacting the liquid crystals in the upper and lower substrates GLS1 and GLS2 of the display panel DIS. A column spacer is formed between the upper and lower substrates GLS1 and GLS2 of the display panel DIS to keep cell gaps of the liquid crystal cells constant.

A backlight unit may be disposed on a back surface of the display panel DIS. The backlight unit may be configured as one of an edge type backlight unit and a direct type backlight unit to provide light to the display panel DIS. The display panel DIS may be implemented in any known mode including a twisted nematic (TN) mode, a vertical alignment (VA) mode, an in-plane switching (IPS) mode, a fringe field switching (FFS) mode, etc.

The display driving circuit includes a data driving circuit 12 and a scan driving circuit 14. The display driving circuit applies a video data voltage of an input image to the pixels of the display panel DIS. The data driving circuit 12 converts digital video data RGB received from the timing controller 20 into positive and negative analog gamma compensation voltages and outputs the data voltage. The data driving circuit 12 then supplies the data voltage to the data lines D1 to Dm. The scan driving circuit 14 sequentially supplies the gate pulse synchronized with the data voltage to the gate lines G1 to Gn and selects lines of the display panel DIS to which the data voltage will be applied.

The timing controller 20 receives timing signals, such as a vertical sync signal Vsync, a horizontal sync signal Hsync, a data enable signal DE, and a main clock MCLK, from an external host system. The timing controller 20 generates a data timing control signal and a scan timing control signal for respectively controlling operation timings of the data driving circuit 12 and the scan driving circuit 14 using the timing signals. The data timing control signal includes a source sampling clock SSC, a source output enable signal SOE, a polarity control signal POL, etc. The scan timing control signal includes a gate start pulse GSP, a gate shift clock GSC, a gate output enable signal GOE, etc.

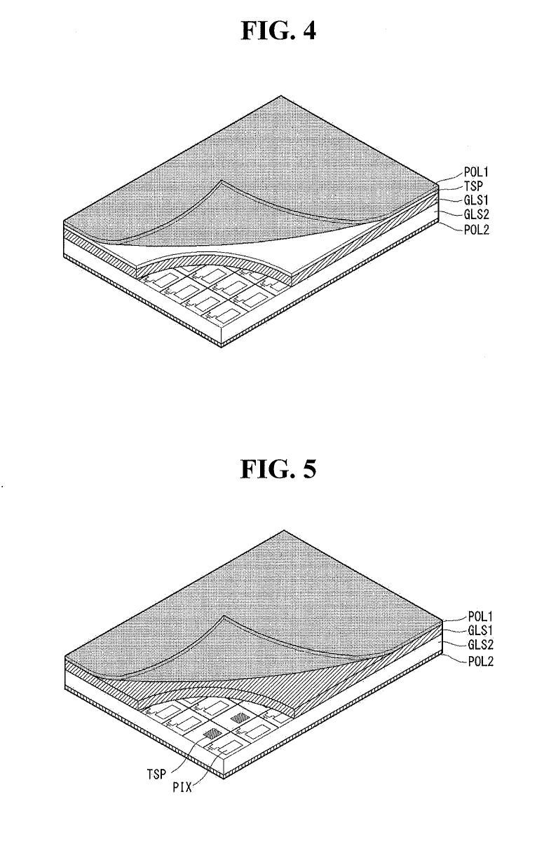

As shown in FIG. 3, the touch screen TSP may be attached on the upper polarizing plate POL1 of the display panel DIS. Alternatively, as shown in FIG. 4, the touch screen TSP may be formed between the upper polarizing plate POL1 and the upper substrate GLS1. Alternatively, as shown in FIG. 5, sensor capacitors TSCAP (refer to FIG. 2) of the touch screen TSP may be formed on the lower substrate GLS2 along with a pixel array of the display panel DIS in an in-cell type. In FIGS. 3 to 5, ‘PIX’ denotes the pixel electrode of the liquid crystal cell.

The touch screen TSP includes Tx channels T1 to Tj (where j is a positive integer less than n), Rx channels R1 to Ri (where i is a positive integer less than m) crossing the Tx channels T1 to Tj, and i×j sensor capacitors TSCAP formed at crossings of the Tx channels T1 to Tj and the Rx channels R1 to Ri.

The touch screen driving circuit includes a Tx driving circuit 32 and an Rx driving circuit 34. The touch screen driving circuit supplies a driving signal to the Tx channels T1 to Tj, senses voltages of the sensor capacitors TSCAP through the Rx channels R1 to Ri, and converts the sensed voltages of the sensor capacitors TSCAP into digital data. The Tx driving circuit 32 and the Rx driving circuit 34 may be integrated into one readout integrated circuit (ROIC).

The Tx driving circuit 32 sets Tx channels in response to a Tx setup signal SUTx received from the touch controller 30 and supplies the driving signal to the set Tx channels T1 to Tj. If the j sensor capacitors TSCAP are connected to one Tx channel, the driving signal may be successively supplied to the one Tx channel j times and then may be successively supplied to a next Tx channel j times in the same manner.

The Rx driving circuit 34 sets Rx channels, which will receive the voltages of the sensor capacitors TSCAP, in response to an Rx setup signal SURx received from the touch controller 30 and receives the voltages of the sensor capacitors TSCAP through the set Rx channels R1 to Ri.

In particular, the Tx driving circuit 32 simultaneously supplies Tx driving signals of antiphase to every two adjacent Tx channels, so as to increase a signal-to-noise ratio (SNR) of touch data. Further, the Rx driving circuit 34 receives a voltage difference between a first sensor capacitor TSCAP receiving a Tx driving signal of a first phase and a second sensor capacitor TSCAP receiving a Tx driving signal of a second phase and accumulates the voltage difference several times, so as to increase the signal-to-noise ratio of the touch data.

The Rx driving circuit 34 converts the accumulated voltage difference into digital data (i.e., touch raw data) and transmits the touch raw data to the touch controller 30.

The touch controller 30 is connected to the Tx driving circuit 32 and the Rx driving circuit 34 through an interface, such as I²C bus, a serial peripheral interface (SPI), and a system bus. The touch controller 30 supplies the Tx setup signal SUTx to the Tx driving circuit 32 and sets the Tx channel, to which a driving signal STx will be output. Further, the touch controller 30 supplies the Rx setup signal SURx to the Rx driving circuit 34 and selects the Rx channels, in which the voltages of the sensor capacitors TSCAP will be read. The touch controller 30 supplies Rx sampling clocks SRx to integrators embedded in the Rx driving circuit 34 and controls operations of the integrators. Hence, voltage sampling timing of the sensor capacitors TSCAP is controlled.

Further, the touch controller 30 supplies analog-to-digital conversion clocks to an analog-to-digital converter (ADC) embedded in the Rx driving circuit 34, thereby controlling operation timing of the ADC.

The touch controller 30 analyzes the touch raw data received from the Rx driving circuit 34 using a previously determined touch recognition algorithm. The touch controller 30 estimates coordinates of touch raw data, which is equal to or greater than a predetermined value, and outputs touch data HIDxy including coordinate information. The touch data HIDxy output from the touch controller 30 is transmitted to the external host system. The touch controller 30 may be implemented as a microcontroller unit (MCU).

The host system may be connected to an external video source equipment, for example, a navigation system, a set-top box, a DVD player, a Blu-ray player, a personal computer (PC), a home theater system, a broadcasting receiver, and a phone system and may receive image data from the external video source equipment. The host system includes a system on chip (SoC) including a scaler and converts the image data received from the external video source equipment into a format suitable for displaying on the display panel DIS. Further, the host system runs an application associated with the coordinates of the touch data received from the touch controller 30.

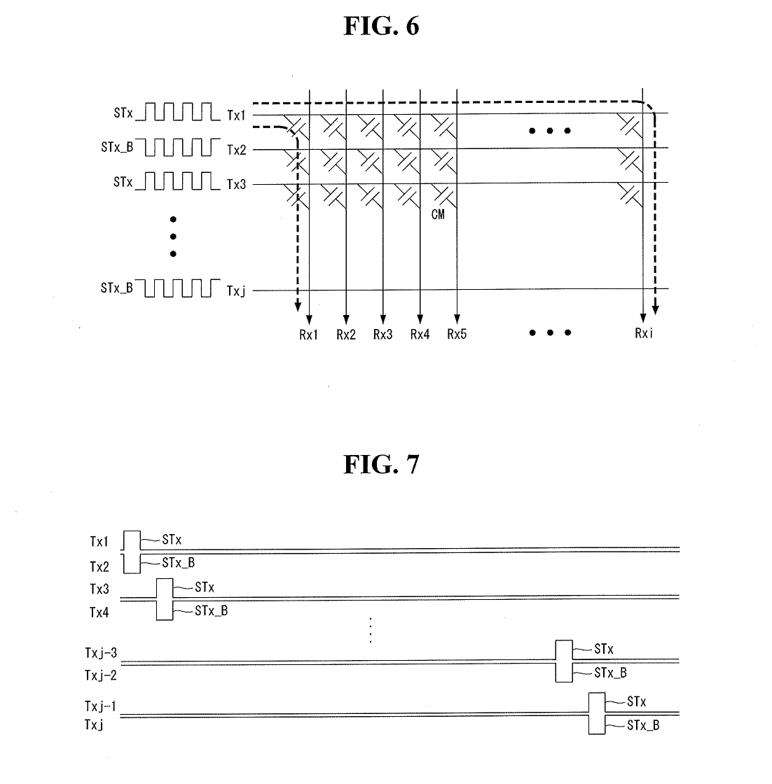

FIG. 6 shows that Tx driving signals of antiphase are supplied to the sensor capacitors formed at crossings of the Tx channels and the Rx channels on the touch screen and adjacent Tx channels. FIG. 7 shows in detail a driving waveform of the Tx driving signals.

The touch screen shown in FIG. 6 includes Tx channels Tx1 to Txj, Rx channels Rx1 to Rxi, and sensor capacitors respectively formed at crossings of the Tx channels Tx1 to Txj and the Rx channels Rx1 to Rxi. Each sensor capacitor has a mutual capacitance. The voltage stored in the sensor capacitor increases in proportional to an amplitude of a Tx driving signal. When the voltage of the sensor capacitor increases by increasing the amplitude of the Tx driving signal, an amount of charges accumulated in the integrator increases. Therefore, it is advantageous to increase the signal-to-noise ratio of the touch data. However, because an output capable range of the integrator is limited, the accumulated voltage exceeds the output capable range of the integrator when the amplitude of the Tx driving signal excessively increases. Hence, the problem of the saturation of the accumulated voltage is generated. The embodiment of the invention applies Tx driving signals STx and STx_B of antiphase, so that the integrator does not individually receive the voltages from the sensor capacitors and receives a voltage difference between the adjacent sensor capacitors, so as to overcome the problem. Namely, the embodiment of the invention simultaneously supplies the Tx driving signals STx and STx_B, which have the same magnitude and is in antiphase, to the two Tx channels respectively connected to the adjacent sensor capacitors. Further, the embodiment of the invention receives the voltage difference between the adjacent sensor capacitors through the Rx channel crossing the two Tx channels receiving the Tx driving signals STx and STx_B of antiphase.

As shown in FIG. 7, the Tx driving signals STx and STx_B of antiphase may be simultaneously supplied to every two adjacent Tx channels. The Tx driving signals STx and STx_B of antiphase may be implemented as a sine wave, a triangle wave, etc. other than a square wave shown in FIG. 7. The Tx driving signals STx and STx_B of antiphase may be supplied to the two adjacent Tx channels several times, so that the voltage difference between the adjacent sensor capacitors is accumulated in the integrator.

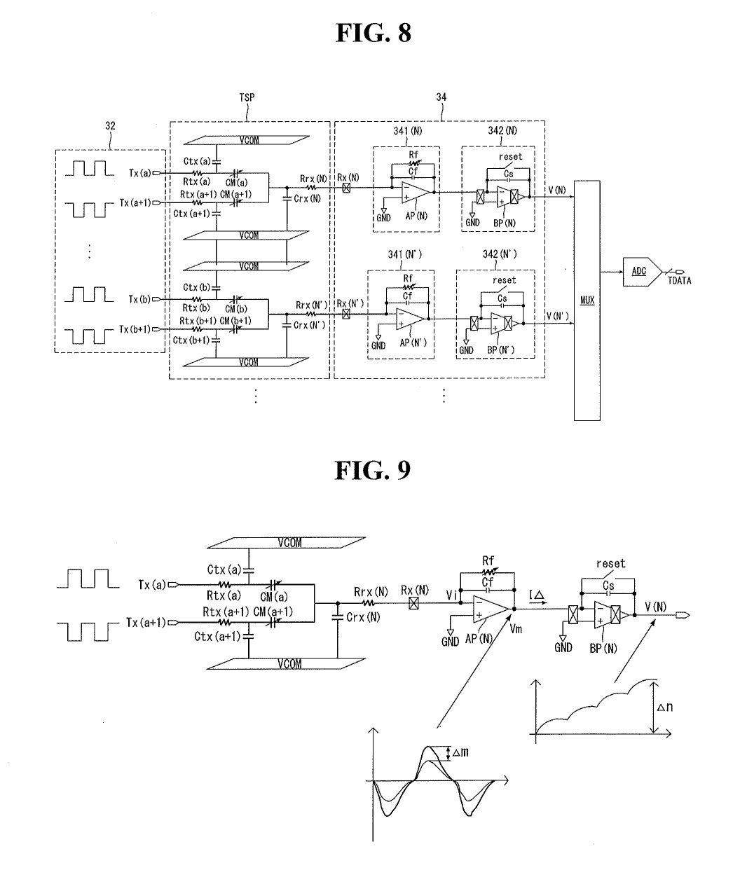

FIG. 8 shows detailed configuration of the touch screen and the Rx driving circuit for increasing the signal-to-noise ratio (SNR) of touch data. FIG. 9 illustrates an operation of one sensing unit shown in FIG. 8.

As shown in FIGS. 8 and 9, the touch screen driving device according to the embodiment of the invention includes a plurality of sensing units. Output voltages V(N) and V(N′) output from the sensing units are selectively input to the ADC through a multiplexer and are converted into digital data through the ADC.

The detailed configuration of one sensing unit is described below.

On the touch screen TSP, adjacent first and second Tx channels Tx(a) and Tx(a+1), an Rx channel Rx(N) crossing the first and second Tx channels Tx(a) and Tx(a+1), a first sensor capacitor CM(a) formed at a crossing of the first Tx channel Tx(a) and the Rx channel Rx(N), and a second sensor capacitor CM(a+1) formed at a crossing of the second Tx channel Tx(a+1) and the Rx channel Rx(N) are formed. In the touch screen TSP, “Ctx(a)” denotes a parasitic capacitance of the first Tx channel Tx(a), “Ctx(a+1)” denotes a parasitic capacitance of the second Tx channel Tx(a+1), “Rtx(a)” denotes a load resistance of the first Tx channel Tx(a), “Rtx(a+1)” denotes a load resistance of the second Tx channel Tx(a+1), “Crx(N)” denotes a parasitic capacitance of the Rx channel Rx(N), “Rrx(N)” denotes a load resistance of the Rx channel Rx(N), and “VCOM” denotes a common electrode to which a common voltage is applied.

The Rx driving circuit 34 includes an integrator 342(N) for accumulating a voltage difference between the first sensor capacitor CM(a) and the second sensor capacitor CM(a+1). The integrator 342(N) receives a voltage difference between a first voltage of the first sensor capacitor CM(a) by a Tx driving signal STx of a first phase and a second voltage of the second sensor capacitor CM(a+1) by a Tx driving signal STx_B of a second phase through the Rx channel Rx(N) and accumulates the received voltage difference several times.

For this, the integrator 342(N) includes an operational amplifier AP(N) having an inverting input terminal (−) receiving the voltage difference, a non-inverting input terminal (+) connected to a ground level voltage source GND, and an output terminal, to which the accumulated voltage difference is output. A sampling capacitor Cs is connected between the inverting input terminal (−) and the output terminal of the operational amplifier AP(N) and accumulates the voltage differences, which is repeatedly input several times. A reset switch for initializing the sampling capacitor Cs is further connected between the inverting input terminal (−) and the output terminal of the operational amplifier AP(N).

The integrator 342(N) further includes a chopper modulator (indicated by a box having a X shape) at each of an input terminal and the output terminal of the operational amplifier AP(N). Hence, the integrator 342(N) may cross-couple the inputs from both terminals of the operational amplifier AP(N) depending on a non-overlap clock phase and may cancel out a common noise and a high frequency noise loaded on the voltage difference.

Because the integrator 342(N) according to the embodiment of the invention is implemented as a single type integrator receiving the voltage difference through only one of the two input terminals (+) and (−), the problem of the saturation about the output capable range of the integrator may be easily solved while minimizing the size of the Rx driving circuit 34.

When the sensor capacitors of the touch screen TSP are formed in the in-cell type as shown in FIG. 5, touch electrode lines (i.e., the Tx channels and the Rx channels) are formed inside the pixel array of the display panel DIS. Therefore, the configuration shown in FIG. 5 is weaker than the configuration shown in FIGS. 3 and 4 in terms of noise. The touch electrode lines (i.e., the Tx channels and the Rx channels) on the in-cell type touch screen TSP are coupled with signal lines (i.e., the data lines and the gate lines) of the pixel array through undesired parasitic capacitances. Therefore, in a related art, the common noise and the problem of the saturation about the output capable range of the integrator were serious because of the Tx riving signal reflected in the RX channel through the parasitic capacitances. Hence, the related art further included a separate charge rejection circuit in front of the integrator and thus solved the above-described problem. However, the charge rejection circuit results in a side effect of an increase in the cost and the size of a circuit design for the touch screen drive. Because the embodiment of the invention transmits the voltage difference between the Tx driving signals of antiphase to the integrator through the Rx channels, the embodiment of the invention may efficiently solve the common noise and the problem of the saturation without the related art charge rejection circuit.

Further, the Rx driving circuit 34 according to the embodiment of the invention further includes an active filter 341(N), so as to filter the voltage difference received from the Rx channel Rx(N). The active filter 341(N) is connected between the Rx channel Rx(N) and the integrator 342(N). The active filter 341(N) filters the voltage difference received from the Rx channel Rx(N) to remove the noise loaded on the voltage difference, and then supplies the filtered voltage difference to the integrator 342(N). The active filter 341(N) is more efficiently used in the in-cell type shown in FIG. 5 weak to the noise. This is because in the in-cell type shown in FIG. 5, the parasitic capacitance is very large, a change amount in voltages of the sensor capacitors is very small, and the in-cell type shown in FIG. 5 is weak to a display noise.

The active filter 341(N) includes an operational amplifier AP(N) having an inverting input terminal (−) receiving the voltage difference, a non-inverting input terminal (+) connected to the ground level voltage source GND, and an output terminal, to which the filtered voltage difference is output. A feedback resistor Rf and a feedback capacitor Cf are connected in parallel to each other between the inverting input terminal (−) and the output terminal of the operational amplifier AP(N). In the embodiment of the invention, the feedback resistor Rf and the feedback capacitor Cf serve as factors determining a gain Vn/Vi of the active filter 341(N) along with a load resistance Rrx(N) of the Rx channel Rx(N). The gain Vn/Vi of the active filter 341(N) is determined by {−(Rrx(N)/Rf)×(1/(1+sRfCf))}. An output bandwidth of the active filter 341(N) is determined by the factors Cf, Rf, and Rrx(N), and thus an amplitude of the signal input to the integrator is determined. In particular, coefficients of the factors Cf and Rf may be variably designed, so that the output bandwidth and the noise frequency of the active filter 341(N) may be adjusted. For this, the feedback resistor Rf and the feedback capacitor Cf may be selected as variable elements. The active filter 341(N) may easily remove the low frequency noise by the adjustment of the noise frequency.

As described above, the embodiment of the invention simultaneously applies the driving signals of antiphase to the adjacent Tx channels, receives the voltage difference between the sensor capacitors formed by the adjacent Tx channels and the Rx channel crossing the adjacent Tx channels, and accumulates the voltage differences, thereby reducing an influence of various noises and increasing the signal-to-noise ratio of the touch data. Hence, the touch reliability may be greatly improved. The embodiment of the invention includes the single type integrator, thereby easily solving the problem of the saturation about the output capable range of the integrator while minimizing the size of the Rx driving circuit.

Furthermore, the embodiment of the invention includes the active filter, which removes the noise included in the voltage difference before accumulating the voltage difference received from the Rx channel in the integrator, and designs the feedback resistor and the feedback capacitor so that the coefficients of the active filter can be adjusted. Hence, the amplitude of the signal input to the integrator can be freely adjusted.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch screen driving device comprising:
a touch screen including a first Tx channel, a second Tx channel adjacent to the first Tx channel, an Rx channel crossing the first and second Tx channels, a first sensor capacitor at a crossing of the first Tx channel and the Rx channel, and a second sensor capacitor at a crossing of the second Tx channel and the Rx channel;
a Tx driving circuit configured to supply a Tx driving signal of a first phase to the first Tx channel and supply a Tx driving signal of a second phase, which is in antiphase of the first phase, to the second Tx channel; and
an integrator configured to receive a voltage difference between a first voltage of the first sensor capacitor by the Tx driving signal of the first phase and a second voltage of the second sensor capacitor by the Tx driving signal of the second phase through the Rx channel and accumulate the received voltage difference several times.

2. The touch screen driving device of claim 1, wherein the Tx driving circuit simultaneously supplies the Tx driving signals of antiphase to the first Tx channel and the second Tx channel.

3. The touch screen driving device of claim 1, wherein the integrator is a single type integrator receiving the voltage difference through only one of two input terminals.

4. The touch screen driving device of claim 3, wherein the integrator includes:
an operational amplifier having an inverting input terminal receiving the voltage difference, a non-inverting input terminal connected to a ground level voltage source, and an output terminal, to which the accumulated voltage difference is output; and
a sampling capacitor which is connected between the inverting input terminal and the output terminal of the operational amplifier and accumulates the voltage difference.

5. The touch screen driving device of claim 1, further comprising an active filter connected between the Rx channel and the integrator and that filters the voltage difference input through the Rx channel, and outputs the filtered voltage difference to the integrator.

6. The touch screen driving device of claim 5, wherein the active filter includes:
an operational amplifier having an inverting input terminal receiving the voltage difference, a non-inverting input terminal connected to a ground level voltage source, and an output terminal, to which the filtered voltage difference is output; and
a feedback resistor and a feedback capacitor connected in parallel to each other between the inverting input terminal and the output terminal of the operational amplifier.

7. The touch screen driving device of claim 6, wherein a noise frequency of the active filter is adjusted by the adjustment of a coefficient of each of the feedback resistor and the feedback capacitor.

8. The touch screen driving device of claim 1, further comprising:
an analog-to-digital converter configured to convert the accumulated voltage difference into digital data; and
a touch controller configured to analyze the digital data using a previously determined touch recognition algorithm and output touch data including coordinate information of a touch position.
